(19) United States
(12) Patent Application Publication
(10) Pub. No.: US 2026/0138825 A1
(43) Pub. Date: May 21, 2026

(54) STORAGE UNIT OF ARTICLES OF SELF-MOVING OR TRANSPORTABLE TYPE, STORE AND METHOD

(71) Applicant: C.M.C. S.P.A., CERBARA-CITTA’DI CASTELLO(PG) (IT)

(72) Inventor: Francesco PONTI, CITTA’DI CASTELLO(PG) (IT)

(73) Assignee: C.M.C. S.P.A., CERBARA-CITTA’DI CASTELLO(PG) (IT)

(21) Appl. No.: 19/117,395

(22) PCT Filed: Oct. 3, 2023
(86) PCT No.: PCT/IB2023/059898

§ 371 Date: Apr. 1, 2025

(30) Foreign Application Priority Data
Oct. 3, 2022 (IT) 102022000020301
Jun. 20, 2023 (IT) 102023000012624

(51) Int. Cl. B65G 1/127; B65G 1/04; B65G 17/12

(52) U.S. Cl. CPC B65G 1/127; B65G 1/0492; B65G 17/12

(57) ABSTRACT

The transportable or self-moving storage unit of articles includes a frame, containers for articles, each including a first part, a second part and an opening, and a support system which supports the containers in such a way that they are movable according to a closed looped pathway, they are overlapped on one another in a first portion, they are overlapped on one another in a second portion, they have the first part above the second part in the first portion, the second part above the first part in the second portion, the opening facing in a moving away direction from the containers of the second portion in the first portion and the opening facing towards the ground surface in a lower portion so as to cause the articles to fall. The containers and the path are configured to prevent falls in the first portion and in the second portion.

### FIELD OF THE INVENTION

The present invention relates to the technical sector concerning logistics, in particular in the management of articles in stores; the term “stores” comprises a variety of situations such as, for example, stores at the service of industrial facilities, stores at the service of sales points and stores at the service of logistics centres.

In greater detail the present invention concerns a'storage unit of articles, self-moving or transportable, as well as a store and a method for collecting articles. The invention also relates to a self-moving storage unit of articles or a system comprising a transportable storage unit of articles and a method for collecting articles. The invention can satisfy two functional needs, with a great degree of flexibility, for example responding to the needs connected to the known processes such as, according to a terminology widely used in the sector, Inbound Logistics, Dynamic Storage Solution, Automated Feeding, Downstream Logistics and Sortering.

### DESCRIPTION OF THE PRIOR ART

The use is known, for example from EP 1920396 A2, of self-moving or transportable shelving units for temporarily storing various articles, for example in logistics centres where the stored articles are collected, packaged and dispatched. In a common approach, the articles coming from various suppliers are identified and catalogued, for example by means of reading the barcodes, temporarily stored in the shelving units with the assignation, to the article, of a position which is memorised by the store management system, collected on the basis of the memorised position, introduced into a receptacle and then prepared for dispatch. The positions of the articles are often defined with identifying codes, for example with barcodes borne by the shelving units.

The receptacle can be used following a plurality of logics, for example for collecting the articles belonging to a same order or for collecting articles belonging to various orders.

Numerous methods and systems are known for storing articles and for managing the articles inside the store, many of which have been set out in patent applications.

Generally, on entry the articles are separated out and catalogued with assignation of an identifying code, often associated to other data such as the mass and dimensions thereof.

While the stores that include the automatic collection of articles are widely known, in the case of self-moving or transportable shelving units the collection is made manually and with limited levels of automation or requires types of automation that are expensive, such as, for example, anthropomorphic robots.

The self-moving or transportable shelving units at present available can reach various stations but to each collection or unloading of the articles there corresponds a new identification of the articles. Several identifications are also realised when the transport of the articles between the various stations takes place using transporters, such as belt conveyors; further, the presence of the belt conveyors limits the spaces available for the logistics.

In other words, the memorised position is no longer of any use once the article has been collected from the shelving unit; the tracing is removed and there emerges a need to assign and memorise a new position on each displacement of the article, following identification.

EP 3256290 B1, with particular reference to FIGS. 3B and 3C, describes a storage unit of articles of the self-moving or transportable type comprising a frame, containers for articles arranged to form a first and a second column and a movement system of the containers between a first inclined position so as to avoid falling of the articles and a second position inclined towards the ground surface which facilitates the collection by a collection system. The solution of EP 3256290 B1 facilitates the collection but does not facilitate the loading and unloading of the articles in their entirety. Further, the above system has a significant size with respect to the volume of articles stored.

### SUMMARY OF THE INVENTION

The present invention intends to obviate one or more drawbacks of the solutions of the prior art.

A first aim is to simplify the management of the articles temporarily stored in stores.

A second aim is to simplify the loading and/or collecting from the store, as well as transfers inside the store.

A further aim of some embodiments is to simplify the design and/or the management of the store.

A further aim is to provide apparatuses which are able to efficiently carry out a plurality of activities of the process without any need for special modifications.

A still further aim is to provide a base apparatus which can easily be customised in the step of realisation or reconfiguration.

These and other aims, which will be obvious to the expert in the sector from a reading of the following text, are attained by means of a storage unit of articles, a storage system of articles, a store of articles or of methods for collecting articles according to the claims.

The storage unit of articles is self-moving or transportable; in a case where it is transportable, i.e. does not have its own displacement means that make it self-moving, it is part of a storage system of articles, or a store of articles which comprises displacement means for displacing the storage unit.

According to the teachings of the present description, the storage unit of articles comprises a frame, containers for articles and a support system.

Each container comprises a first part, a second part and, between the first part and the second part, an opening for entry and outlet of the articles.

The support system advantageously supports the containers in such a way that:
the containers are movable with respect to the frame according to a closed looped pathway which has an upper portion, a lower portion, a first portion which extends in a vertical direction or vertically and a second portion which extends in a vertical direction or vertically, with the upper portion and the lower portion both being interposed between the first portion and the second portion;
a plurality of containers are mutually overlapped in the first portion and a plurality of containers are mutually overlapped in the second portion;
each container has the first part above the second part in the first portion, the second part above the first part in the second portion and the opening facing in a moving away direction from the containers of the second portion in the first portion.

Further, the containers and the pathway are configured in such a way that the second part in the first portion and the first part in the second portion are horizontal or inclined with respect to a horizontal plane so as to prevent the falling of the articles.

A like storage unit of articles can easily be customised in the step of realisation or reconfiguration, as in the embodiments illustrated in detail and shown by way of example in the drawings enable observing.

Typically, though not necessarily, the support system supports the containers in such a way that each container has the opening facing towards the ground surface in the lower portion so as to cause the articles to fall by the force of gravity.

The storage unit of articles can possibly comprise movement means for moving the support system so as to move the containers with respect to the frame.

According to the teachings of the present description, the store of articles comprises at least a storage unit of articles according to the present description, movement means for moving the support system so as to move the containers with respect to the frame (possibly a part of the storage unit of articles), displacement means for displacing the frame of the at least a storage unit of articles (possibly a part of respective storage units of articles), a first station for loading and/or collecting articles, a storage area of the at least a storage unit of articles (and/or a second station for loading and/or collecting articles), and a store management system which controls the displacement means and the movement means.

According to the teachings of the present description, the method comprises steps of:
providing at least a storage unit of articles according to the present description;
providing articles;
placing the articles in the containers in the second portion and/or in the first portion;
collecting an article.

Preferably, though not necessarily, the step of collecting an article includes moving the support system until the container that contains it is in the lower portion.

### BRIEF DESCRIPTION OF THE DRAWINGS

Specific embodiments of the invention will be described in the following part of the present description, according to what is set down in the claims and with the aid of the accompanying figures, in which:

FIG. 1 illustrates a perspective lateral view of an embodiment of a storage unit of articles according to the invention;

FIG. 2 shows a detail of the embodiment of FIG. 1;

figures from 3 to 5 illustrate an automatic loading sequence of the embodiment of FIG. 1;

figures from 6 to 8 illustrate an automatic collecting sequence of the embodiment of FIG. 1;

FIG. 9 illustrates a perspective view of two units or modules of a further embodiment of a storage unit of articles according to the invention;

FIG. 10 illustrates a perspective view of a unit of the embodiment of FIG. 9;

FIGS. 11 and 12 are details of the embodiment of FIG. 9, with some elements not included so as to facilitate understanding of the functional and structural characteristics;

FIG. 13 illustrates a section (without background) of a container of the embodiment of FIG. 9 according to a vertical plane cutting all containers;

FIG. 14 illustrates a perspective view of a unit of the embodiment of FIG. 9 in a first station;

FIG. 15 is a detail from different viewpoint of FIG. 14;

FIG. 16 illustrates a first station of an embodiment of a store of articles according to the invention;

FIG. 17 illustrates a perspective view from above of an embodiment of a store of articles according to the invention;

FIG. 18 illustrates a perspective lateral view of the embodiment of FIG. 17;

FIG. 19 illustrates a schematic view from above of a further embodiment of a store of articles according to the invention;

FIGS. 20 and 21 are schematic views of some embodiments of the storage unit of articles according to the invention;

FIG. 22 illustrates a perspective lateral view of another embodiment of a transportable storage unit of articles according to the invention which is part of a storage system of articles, the storage unit of articles comprising a vertically movable temporary magazine and illustrated in a loading and/or unloading position in which it can receive articles from the containers by force of gravity;

FIG. 23 illustrates a perspective lateral view of another embodiment of a self-moving storage unit of articles according to the invention, comprising the temporary magazine already referenced in FIG. 22;

FIG. 24 is a perspective lateral view of the self-moving storage unit of articles of FIG. 22;

FIG. 25 is a perspective lateral view of the self-moving storage unit of articles of FIG. 23;

FIG. 26 is a perspective view of the receiving of an article by force of gravity in the temporary magazine of the storage unit of articles of FIG. 22 or 23;

FIG. 27 illustrates a perspective lateral view of the locating of the article of FIG. 26 in shelving unit;

FIG. 28 is a perspective lateral view of the storage unit of articles of FIG. 22 in front of a shelving unit, this view is an example of the vertical movement of the temporary magazine in order to locate or extract articles from the shelving unit, as well as to locate the temporary magazine at a container;

FIG. 29 is a perspective lateral view of the storage unit of articles of FIG. 22 in front of a shelving unit that gives an example of the step of extracting articles from the shelving unit;

FIG. 30 is a perspective lateral view of the storage unit of articles of FIG. 22 in front of a shelving unit that gives an example of a step of filling a container which follows the steps of FIGS. 28 and 29;

FIG. 31 is a perspective lateral view of the storage unit of articles of FIG. 22 in front of loading means, in a similar way to FIG. 5;

FIG. 32 is a perspective lateral view of the example scene of FIG. 31, from a different viewpoint;

FIG. 33 illustrates a perspective view of a unit of a store of articles, with a storage unit of articles according to the invention, in a view in which the scenes illustrated in FIGS. 30 and 31 are visible;

FIG. 34 is a perspective lateral view of the self-moving base of the storage unit of articles of FIG. 23;

FIG. 35 is a perspective view of the self-moving base of FIG. 34, from a different viewpoint.

### DESCRIPTION OF PREFERRED EMBODIMENTS

With reference to the appended figures, reference numeral 1 denotes a storage unit (1) of articles, which is self-moving or transportable, without distinguishing between the various embodiments illustrated in the following and in the drawings. The references are reported to facilitate understanding of the invention, but are not intended to limit the scope of the invention.

In the case of self-moving storage unit (1) of articles, preferably this comprises drive wheels (73a).

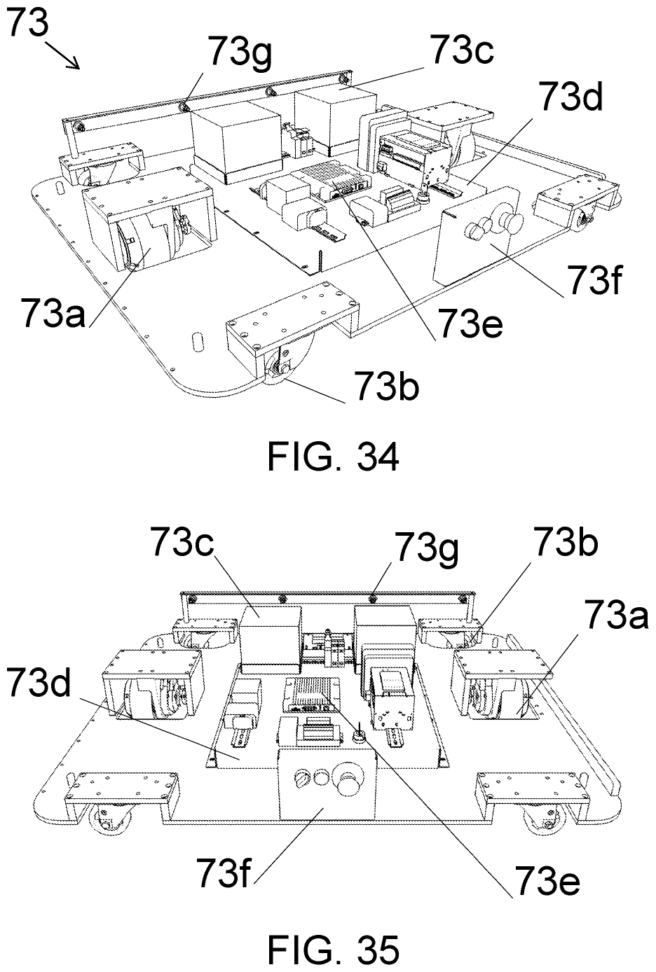

In a preferred embodiment the storage unit (1) of articles comprises a self-moving base (73) that comprises drive wheels (73a), a control unit (73d) which controls the drive wheels (73a) and a battery unit (73c) which powers the control unit (73d) and the drive wheels (73a). In FIGS. 34 and 35 the self-moving base (73) also comprises pivoting wheels (73b), a navigation device (73e) functionally associated to the control unit (73d), a commands panel (73f), comprising a safety switch, and anti-collision sensors (73g).

In the case of a transportable storage unit (1) of articles, the frame (2) preferably comprises rest feet (200) for resting on the ground surface (G); these are particularly useful as they provide, to the displacement means, a volume beneath the containers (3). These displacement means preferably comprise at least an automatically-guided or autonomous vehicle (71). As is known to the technical expert in the field, a group of automatically-guided or autonomous vehicles (71) can move a plurality of storage units of articles (1) interchangeably and/or with the possibility of having a storage unit (1) of articles not associated to any automatically-guided or autonomous vehicle (71) for a period of time.

An embodiment of the storage unit of articles (1) of the self-moving or transportable type comprises a frame (2), containers (3) for articles (A) and a support system (5) which supports the containers (3).

Each container (3) comprises a first part (31), a second part (32) and, between the first part (31) and the second part (32), an opening (33) for entry and outlet of the articles (A).

The support system (5) advantageously supports the containers (3) in such a way that, i.e. is configured in such a way that:
the containers (3) are movable with respect to the frame (2) according to a closed looped pathway which has an upper portion (50a), a lower portion (50b), a first portion (50d) which extends in a vertical direction and a second portion (50e) which extends in a vertical direction, with the upper portion (50a) and the lower portion (50b) both being interposed between the first portion (50d) and the second portion (50e);
a plurality of containers (3) is mutually overlapped in the first portion (50d) and a plurality of containers (3) is mutually overlapped in the second portion (50e);
each container has the first part (31) above the second part (32) in the first portion (50d), the second part (32) above the first part (31) in the second portion (50e), the opening (33) facing in a moving away direction from the containers (3) of the second portion (50e) in the first portion (50d) and the opening (33) facing towards the ground surface (G) in the lower portion (50b) so as to cause the fall of the articles (A) by force of gravity.

Further, the containers (3) and the pathway are configured in such a way that the second part (32) in the first portion (50d) and the first part (31) in the second portion (50e) are horizontal or inclined with respect to a horizontal plane (H) so as to prevent the falling of the articles (A).

The storage unit (1) of articles facilitates automation of the operations of a store (100) of articles (A) and can be advantageously used in several steps of the process and/or areas of the store (100) of articles (A).

The articles (A) are stored in height, reducing the occupation of ground surface, and with a structure that enables good flexibility both when loading and collecting, as will be more fully clarified in the following.

An embodiment of the self-moving storage unit (1) of articles comprises a frame (2), containers (3) for articles (A), displacement means for displacing the frame (2) in space, a support system (5) which supports the containers (3) and movement means (6) for moving the support system (5) so as to move the containers (3) with respect to the frame (2).

The displacement means move the frame (2) at least between a first spatial position and a second spatial position, and typically move the frame (2) among various points of a store (100) of articles (A).

Each container (3) comprises a first part (31), a second part (32) and, between the first part (31) and the second part (32), an opening (33) for entry and outlet of the articles (A).

The support system (5) advantageously supports the containers (3) in such a way that, or is configured so that:
the containers (3) are movable with respect to the frame (2) according to a closed looped pathway which has an upper portion (50a), a lower portion (50b), a first portion (50d) which extends vertically and a second portion (50e) which extends vertically, with the upper portion (50a) and the lower portion (50b) being both interposed between the first portion (50d) and the second portion (50e);
a plurality of containers (3) is mutually overlapped in the first portion (50d) and a plurality of containers (3) is mutually overlapped in the second portion (50e);
each container has the first part (31) above the second part (32) in the first portion (50d), the second part (32) above the first part (31) in the second portion (50e) and the opening (33) facing in a moving away direction from the containers (3) of the second portion (50e) in the first portion (50d).

Further, the containers (3) and the pathway are configured in such a way that the second part (32) in the first portion (50d) and the first part (31) in the second portion (50e) are horizontal or inclined, preferably inclined with respect to a horizontal plane (H) so as to prevent the falling of the articles (A).

The invention also relates to a storage system of articles (A).

An embodiment of the storage system of articles (A) comprises a transportable storage unit of articles (1) and displacement means.

The transportable storage unit (1) of articles comprises a frame (2) and containers (3) for articles (A), each comprising a first part (31), a second part (32) and, between the first part (31) and the second part (32), an opening (33) for entry and outlet of the articles (A). The displacement means move the frame (2) at least between a first spatial position and a second spatial position, and typically move the frame (2) among various points of a store (100) of articles (A).

Similarly to the above, the transportable storage unit (1) of articles comprises a support system (5) which supports the containers (3) in such a way, or is configured in such a way that:
the containers (3) are movable with respect to the frame (2) according to a closed looped pathway which has an upper portion (50a), a lower portion (50b), a first portion (50d) which extends vertically and a second portion (50e) which extends vertically, with the upper portion (50a) and the lower portion (50b) being both interposed between the first portion (50d) and the second portion (50e);
a plurality of containers (3) is mutually overlapped in the first portion (50d) and a plurality of containers (3) is mutually overlapped in the second portion (50e);
each container has the first part (31) above the second part (32) in the first portion (50d), the second part (32) above the first part (31) in the second portion (50e) and the opening (33) facing in a moving away direction from the containers (3) of the second portion (50e) in the first portion (50d).

Further, the containers (3) and the pathway are configured in such a way that the second part (32) in the first portion (50d) and the first part (31) in the second portion (50e) are horizontal or inclined, preferably inclined with respect to a horizontal plane (H) so as to prevent the falling of the articles (A).

The storage unit (1) of articles, whether self-moving and when transportable, facilitates automation of the operations of a store (100) of articles (A) and can be advantageously used in several steps of the process and/or areas of the store (100) of articles (A).

The articles (A) are stored in height, reducing the occupation of ground surface, and with a structure that enables good flexibility both when loading and collecting, as will be more fully clarified in the following.

Given the substantial overlapping of the characteristics and advantages of the self-moving storage unit (1) of articles and the storage system of articles (A), the description will describe them as though they were the same as it is clear that the characteristics of the displacement means differ from one another, since a storage system of articles (A) with an autonomously-driven vehicle connected to the transportable storage unit (1) of articles is substantially equivalent to the self-moving storage unit (1) of articles.

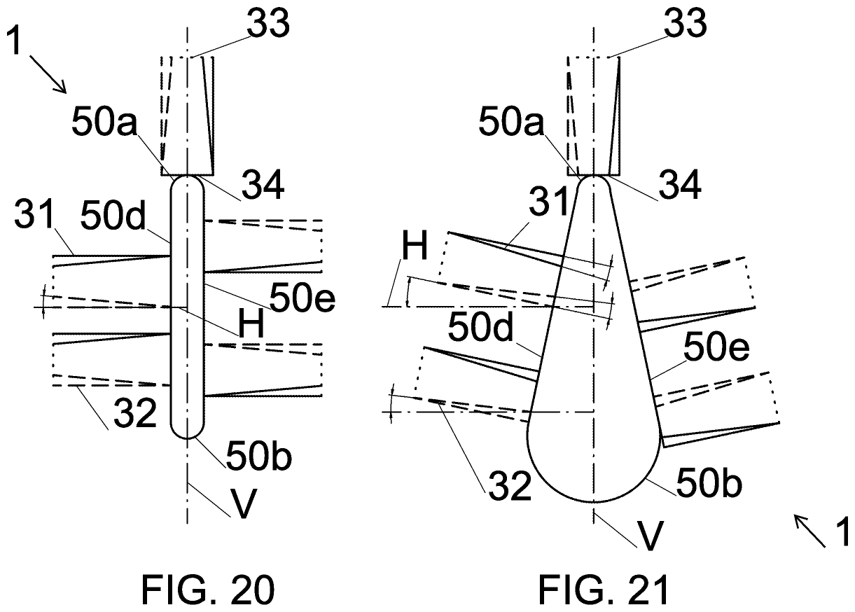

For each embodiment of the storage unit of articles (1) illustrated in the foregoing, i.e. of the self-moving or transportable type, self-moving or transportable, the expert in the sector will understand that there are numerous possible variants of the support system (5) which enable support of the containers (3) as described in the foregoing, i.e. with the use of different moving members with respect to the frame (2) and/or different couplings between the containers (3) and the same moving members. Purely by way of example, each single container (3) might be moved independently by a device along a guide or the containers (3) might be coupled to a same member or the containers (3) might be fixed with respect to the device or member, or be movable with respect to one thereof. Also, FIGS. 20 and 21 schematically illustrate how it is possible to avoid the fall of articles (A) by acting on the shape of the containers (3) and/or on the pathway. In these figures, various lines are used to identify the first part (31) and the second part (32) with an indication of the angles of inclination with respect to a horizontal plane (H) and/or with respect to a container (3) with the first part (31) and the second part (32) being perpendicular to the pathway. FIG. 20 shows how the section of the container (3) can be reduced towards the opening (34) so as to prevent the falling of the articles (A).

FIG. 21 shows how the inclination of the pathway might serve the same purpose.

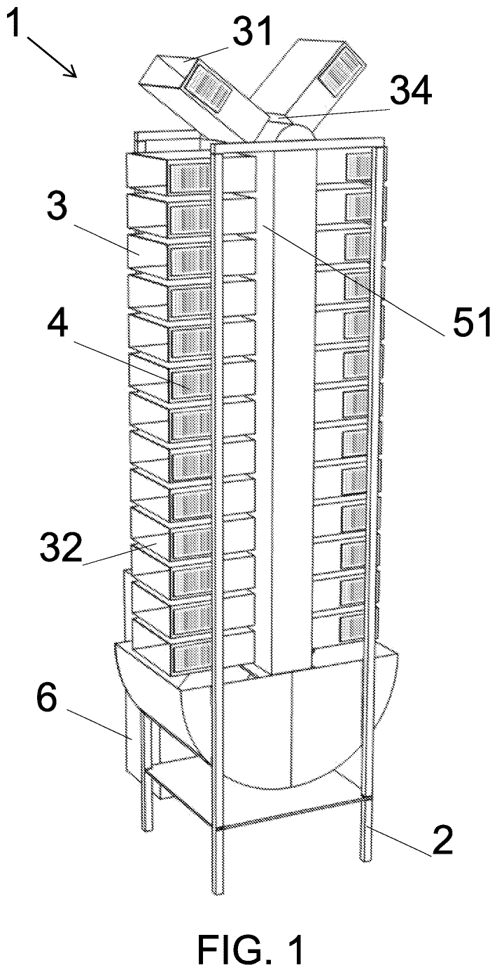

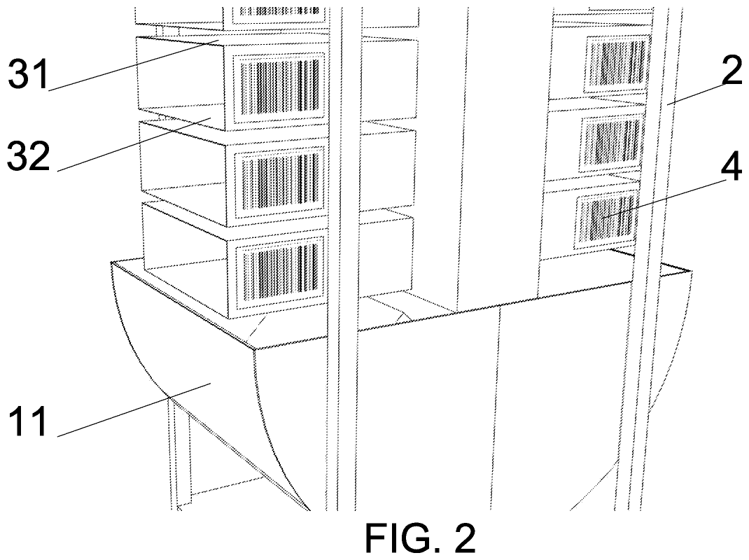

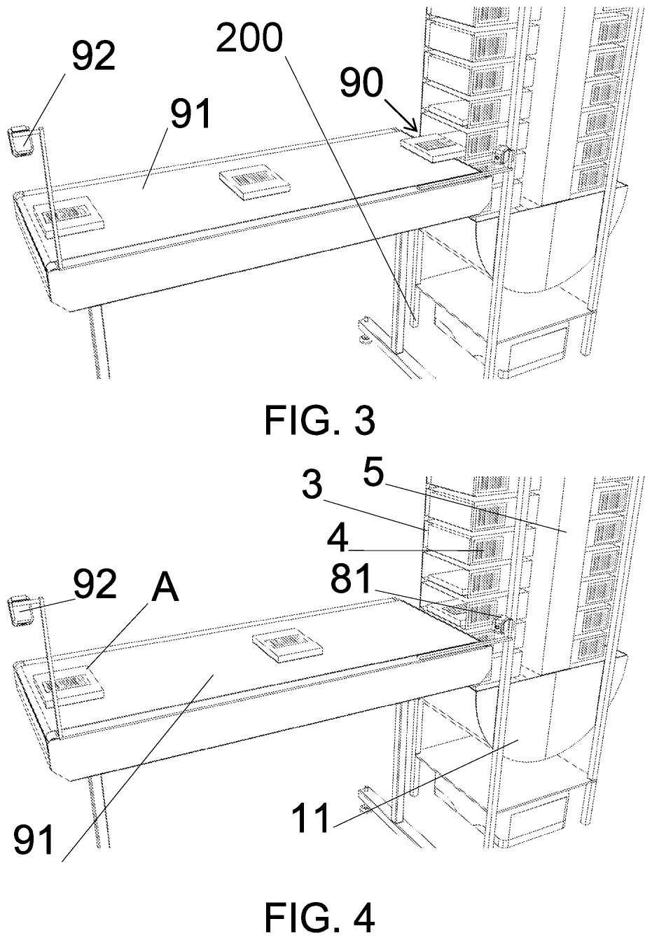

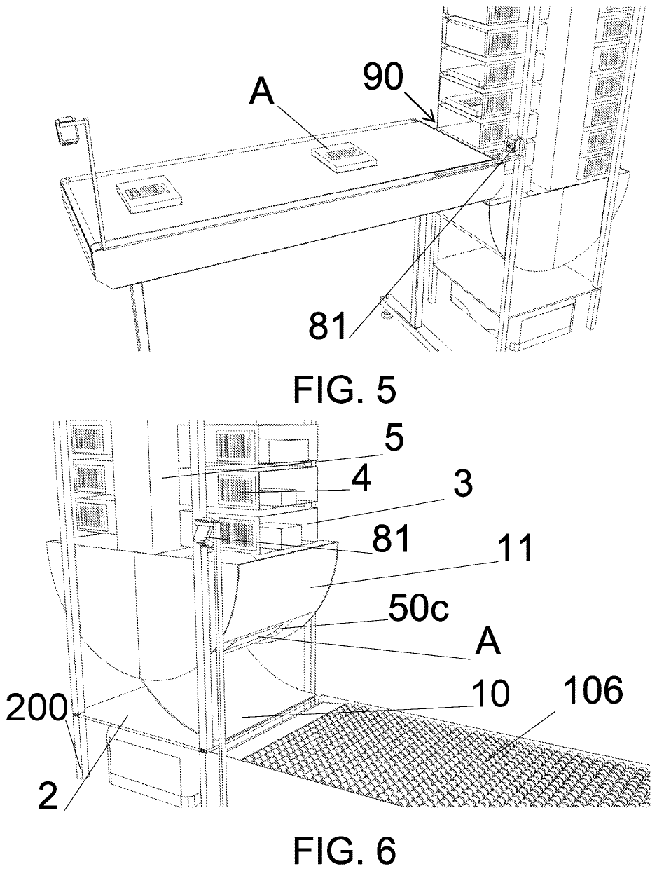

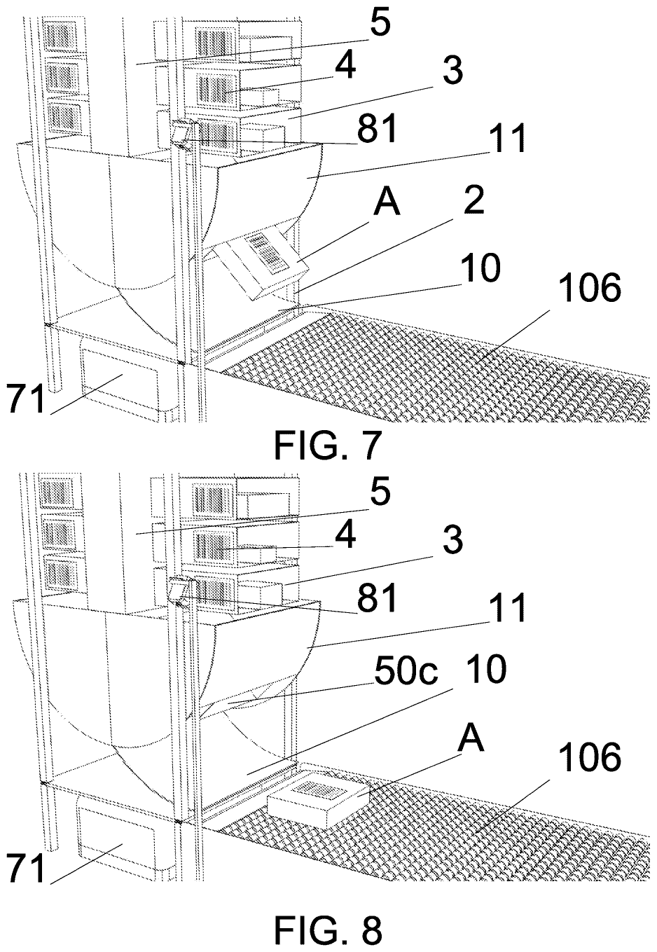

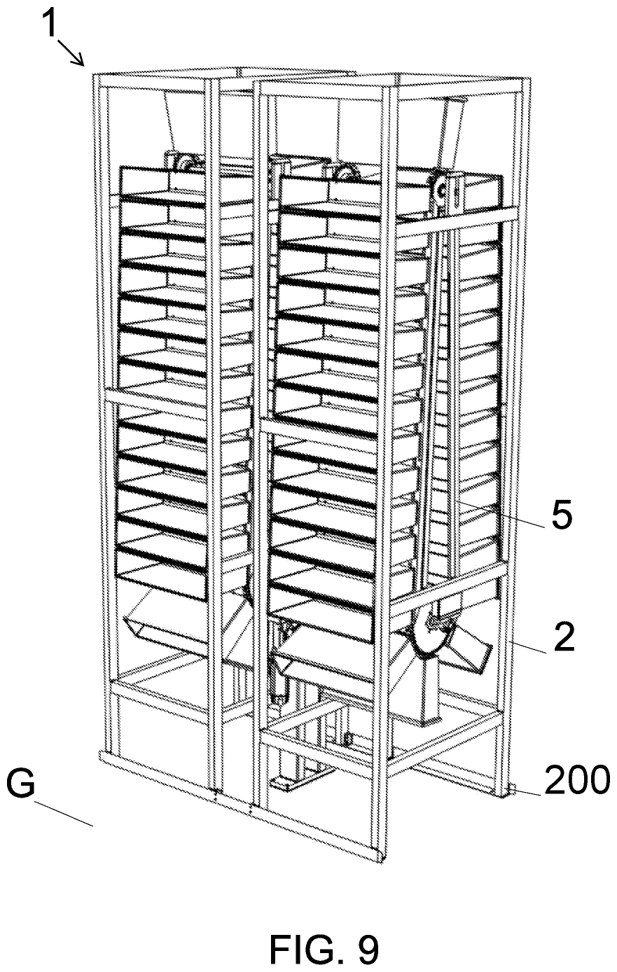

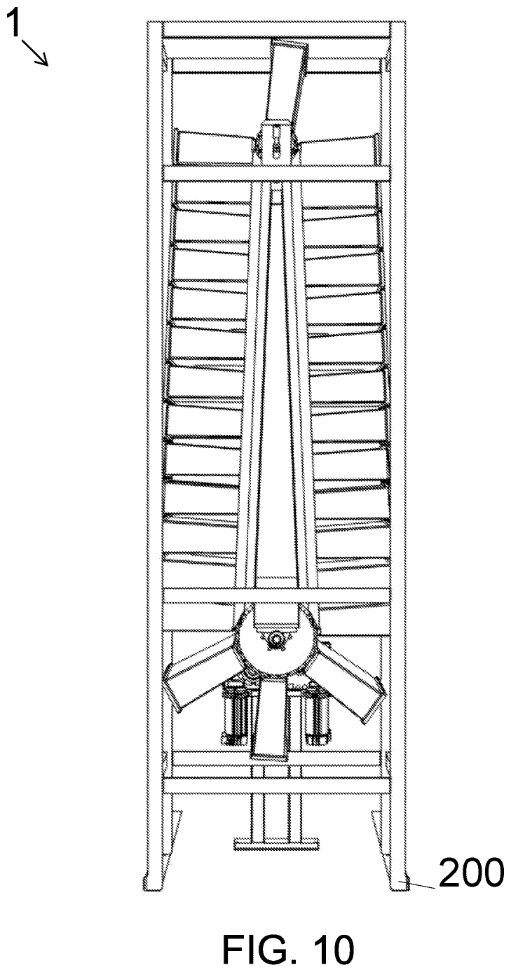

Some preferred characteristics will be described in the following; FIGS. 1 and 9 show preferred embodiments which simplify the realisation and/or obtain further advantages.

As is clearly illustrated in the accompanying figures, the pathway is designed to stack articles (A) vertically, i.e. so as to have a large number of containers (3) in the first portion (50d) and the second portion (50e).

It is specified that in the present description the expression “in the portion” is equivalent to “at the position of the portion”, i.e. it indicates the part of the pathway that is being crossed.

The opening (33) in moving away direction simplifies the lateral loading and, more preferably, the support system (5) supports the containers (3) so that each container (3) in the second portion (50e) has the opening (33) facing in a moving away direction from the containers in the first portion (50d).

This characteristic is preferably obtained by making the container (3) solidly constrained to a part of a flexible organ (51, 52) of the support system (5) with the opening (33) facing in a moving away direction from the pathway.

The openings (33) in view on both sides enable greater control of the storage unit (1) of articles, for example when the storage unit (1) is paused in a storage area (103).

Preferably at least one, more preferably both, between the first portion (50d) and the second portion (50e) is perpendicular with respect to a horizontal plane (H), thus reducing the footprint on the ground surface as schematically illustrated in FIG. 20.

At least one from and preferably both, between the first portion (50d) and the second portion (50e) is preferably inclined with respect to a vertical plane (V) in such a way that the pathway broadens towards the lower portion (50b). In this case, especially in the case of containers (3) constrained to a part of a flexible organ (51, 52), the likelihood of articles (A) falling is reduced, as can be seen in FIG. 21.

Theoretically the configurations of FIGS. 20 and 21 can be combined, for example with a perpendicular first portion (50d) and an inclined second portion (50e).

An inclined portion makes the exiting of the articles (A) more difficult and/or enables using containers (3) having a section which broadens towards the opening (33). This possibility can be exploited to more easily realise the containers (3) by moulding and/or to limit the displacement of the articles (A) in the movement of the containers (3) given an equal opening (33).

The self-moving storage unit (1) of articles or the transportable storage unit (1) of articles preferably comprises a temporary magazine (20).

The temporary magazine (20):
comprises a first access (21) for passage of the articles (A) on a first side;
comprises a second access (22) for passage of the articles (A) on a second side opposite the first side;
comprises transfer means for transferring articles (A) through the first access (21) and/or for transferring articles (A) through the second access (22).
is vertically movable with respect to the frame (2) passing from at least a loading and/or unloading position (CS) in which the first access (21) is facing towards an opening (33) so as to enable the transfer of the articles (A) from and/or towards a container (3).

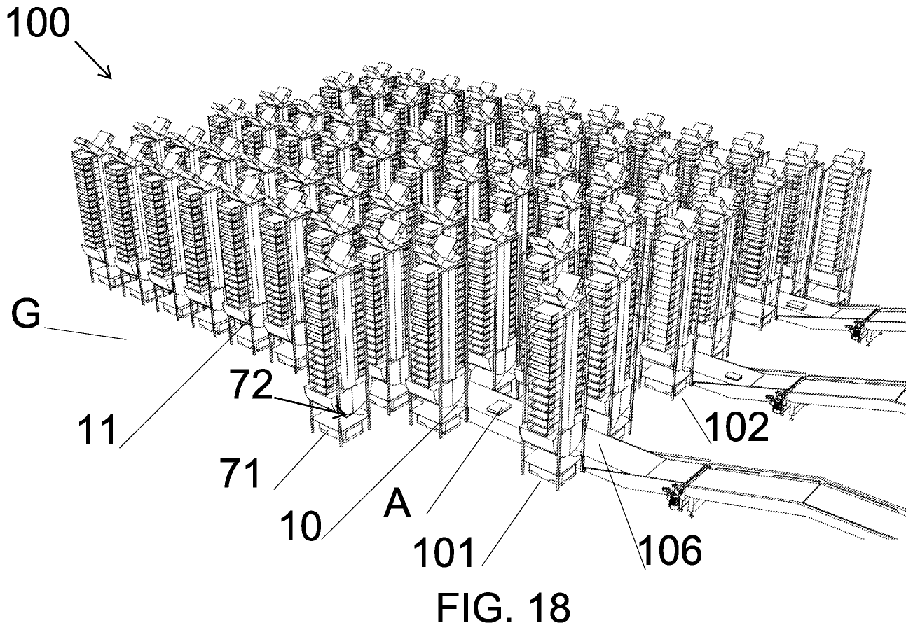

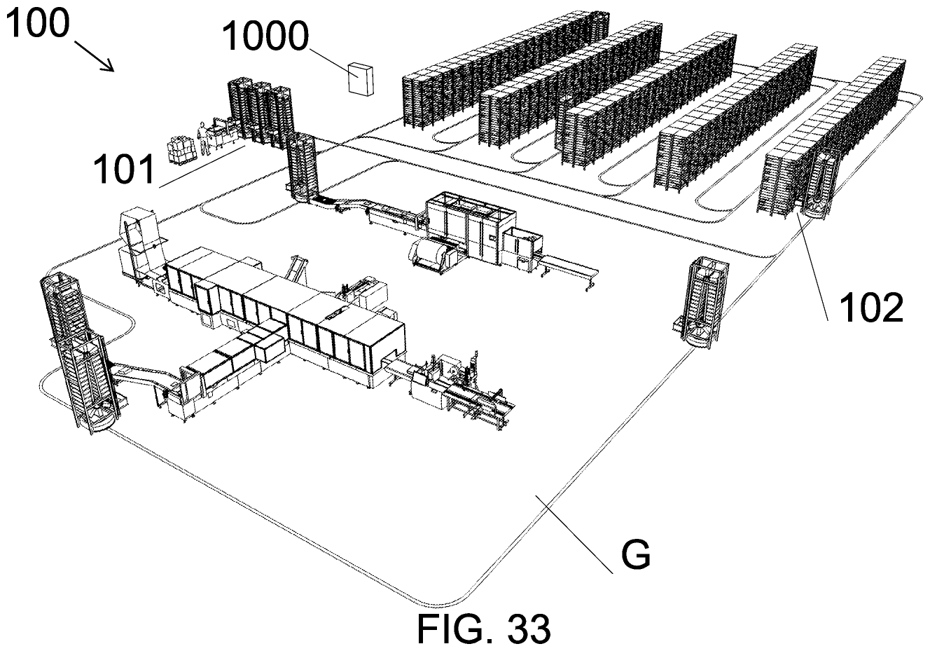

The temporary magazine (20) ensures further flexibility and facilitates the operations, as well as allowing the placing or extraction of articles (A) to and from traditional shelving units. A comparison between FIGS. 18 and 33 enables understanding of how numerous variants of stores (100) for articles (A) are possible which exploit the present invention and how the temporary magazine (20) enables interaction with shelving units of a traditional type, or in any case different from those of the invention.

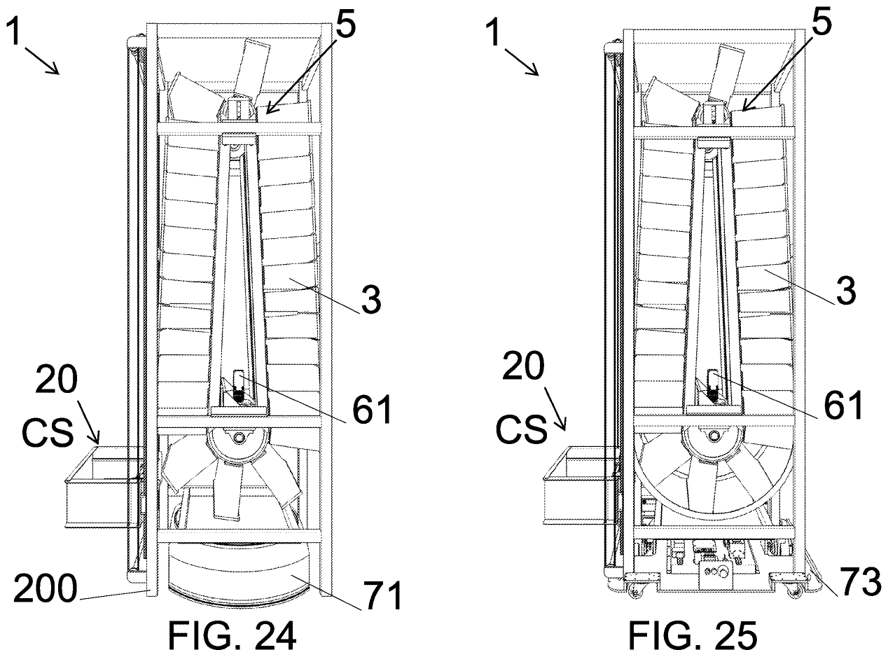

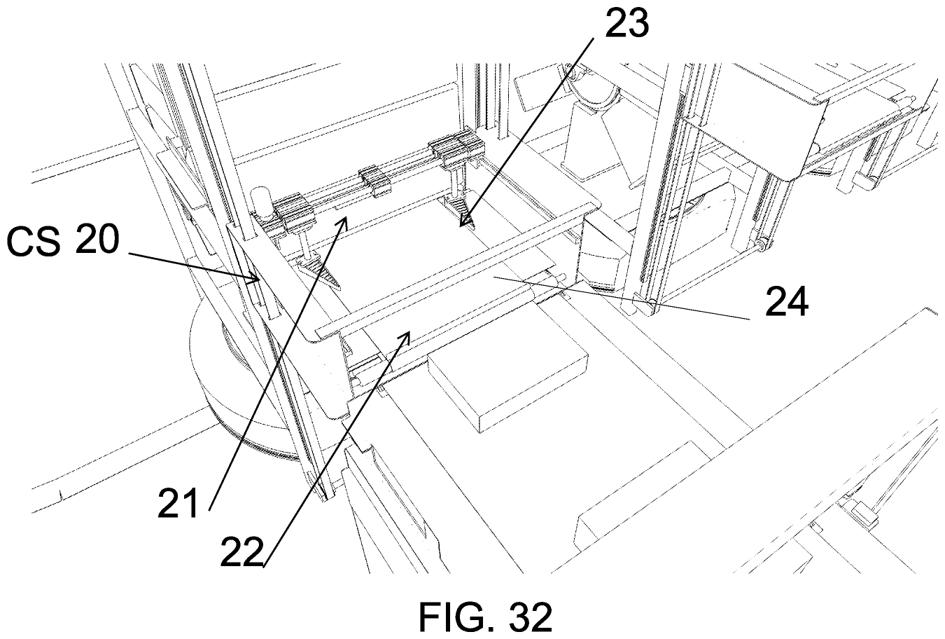

Different positions of the at least a loading and/or unloading position (CS) are illustrated in FIGS. 24 and 32.

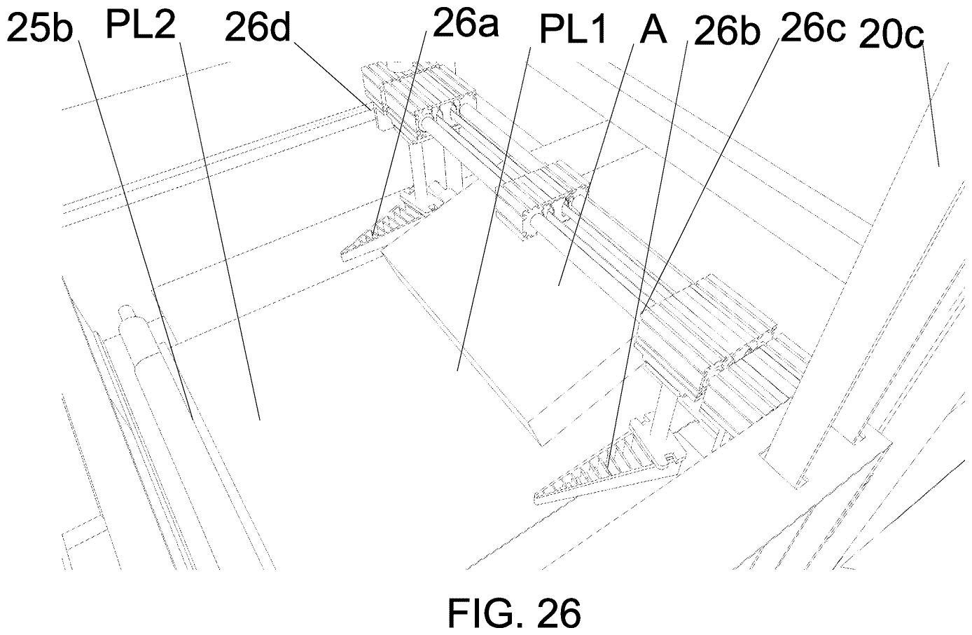

Figures from 22 to 24 show examples of the receiving of articles (A) from a container (3), so as to be able thereafter to vary the height of the article (A) with respect to the ground surface, according to the destination. In particular FIG. 26 shows the receiving of an article (A) by force of gravity, i.e. falling under its own weight.

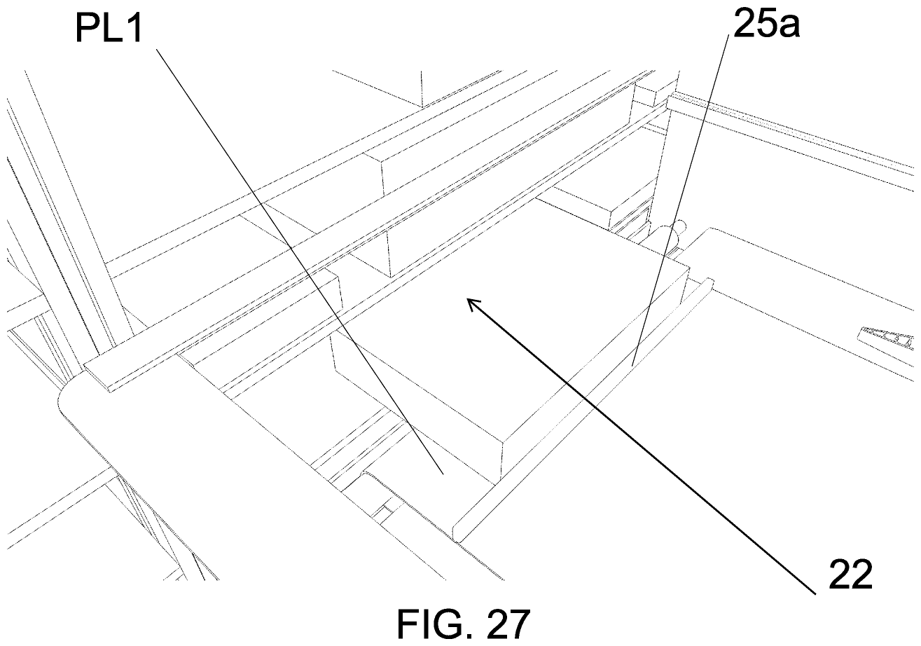

FIG. 27 illustrates the placing of an article (A) using the temporary magazine (20) after the displacement from a first station (101) to a second station (102).

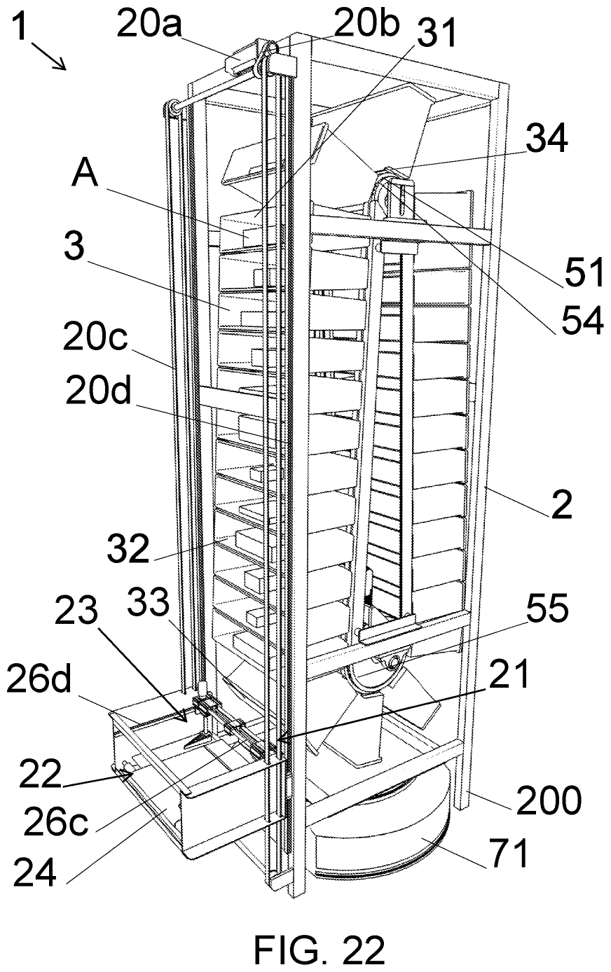

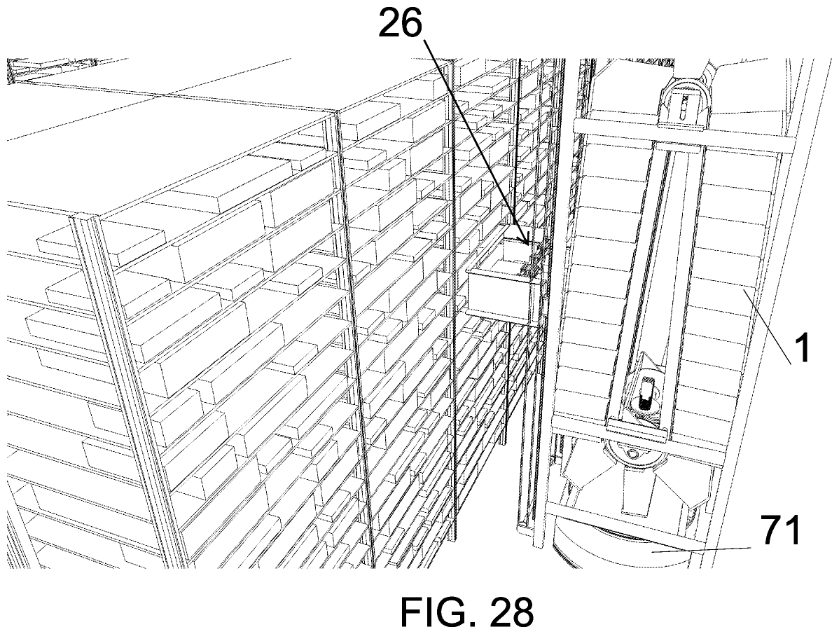

In FIG. 28 the temporary magazine (20) is raised with respect to FIGS. 22 and 24; this position exemplifies both a locating position and an extracting position of the articles (A) from the shelving unit.

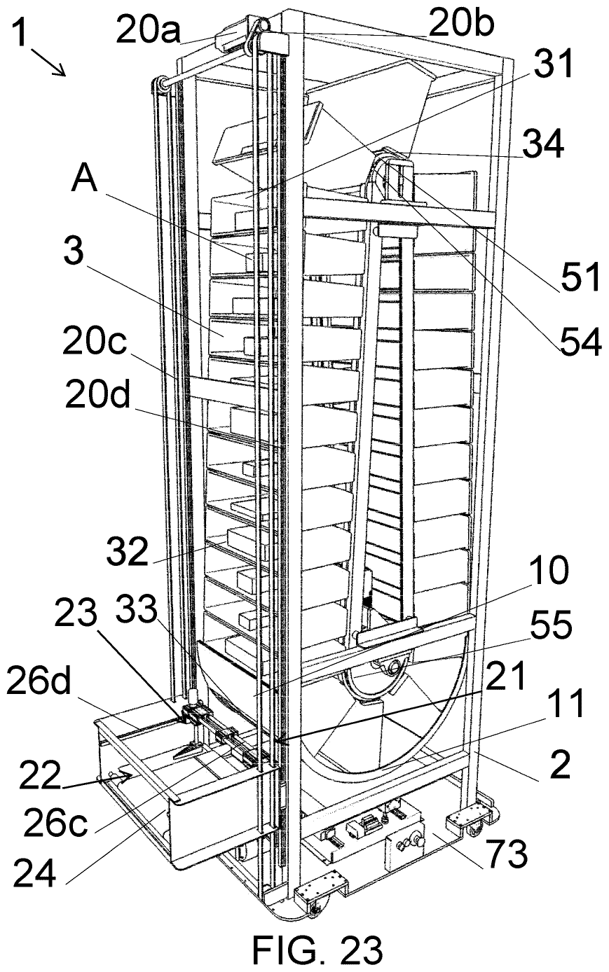

FIG. 22 does not illustrate the containment means (11), but they might have been clearly present, including together with one or more doors (10), as in the case of FIG. 23.

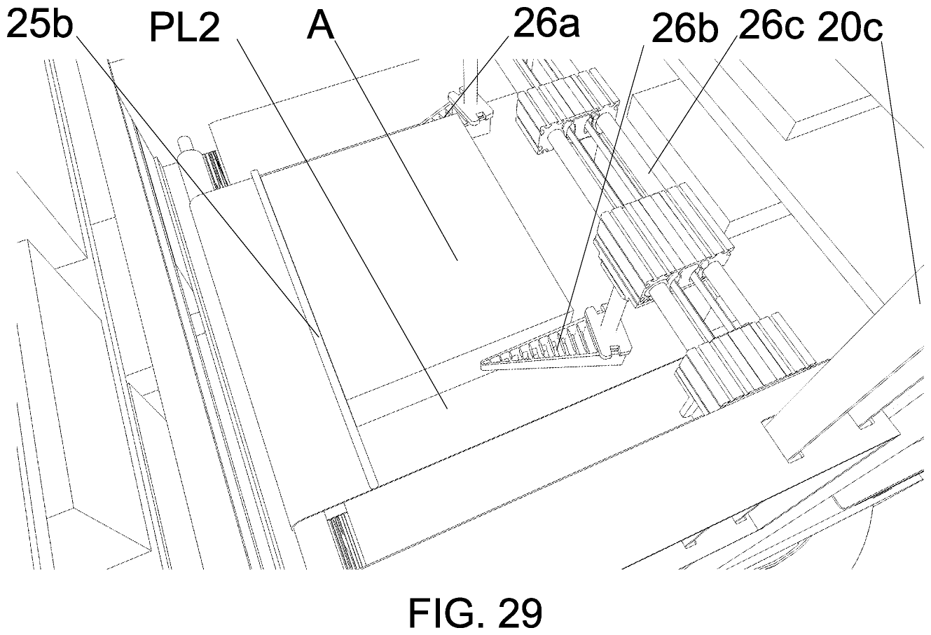

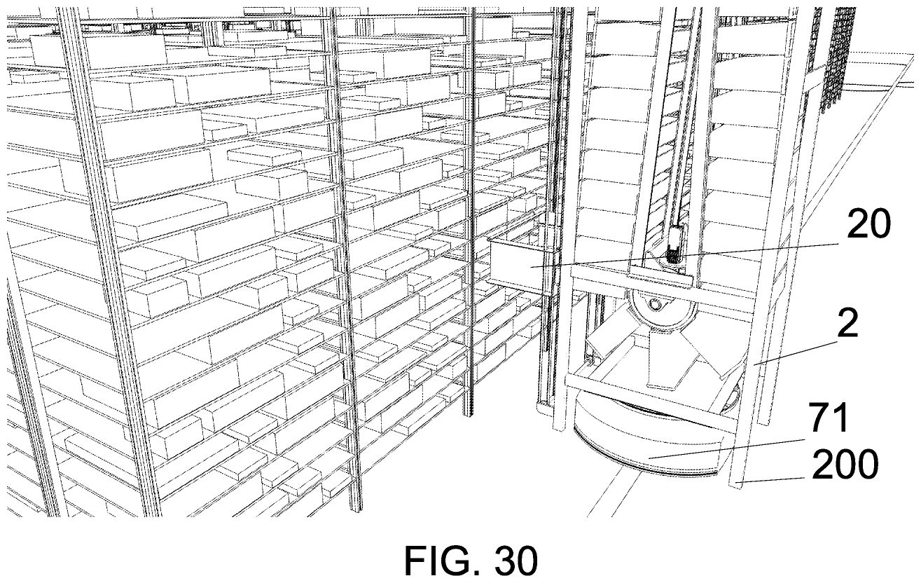

FIG. 29 illustrates the extraction of an article (A) with a pick-up unit (26). The filling of a container (3) generally follows a vertical displacement of the temporary magazine (20), as shown by way of example in a comparison between FIG. 29, the step of extraction, and FIG. 30, the step of filling of a container (3). In this regard, it is observed that, although the filling of the container (3) can theoretically take place at any height, it preferably takes place at a lower position in the case where the first portion (50d) is inclined with respect to a vertical plane (V).

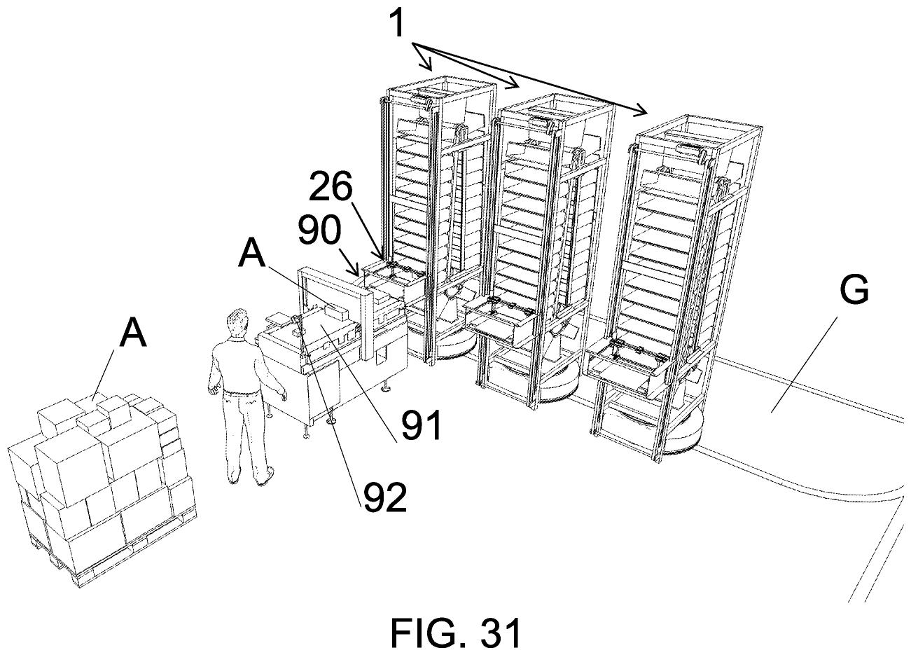

FIGS. 31 and 32 illustrate an inbound step. In this case the temporary magazine (20) might not be used and the filling takes place on the second portion (50e). However the presence thereof can be useful for ensuring the correct positioning of the articles (A) inside the containers (3). In fact the temporary magazine (20) guarantees a precise positioning with respect to the openings (33), enabling using generic-type loading means, for example at a height from the ground surface of the belt conveyor (91) that is different to the optimal height, for filling the containers (3).

The temporary magazine (20) can have a third access (23) facing superiorly, in a moving away direction from the ground surface (G), so as to receive the articles (A) from above, in this case too facilitating the filling of the articles (A) by unsuitable loading means, or loading means that are not properly suitable, for the direct loading of the containers (3).

FIG. 33 illustrates the flexibility of a store (100) of articles (A), also comprising, in the centre and bottom, two machines for boxing or packaging articles (A). The temporary magazine (20) can possibly also be used for locating articles (A) on these machines, but unloading by force of gravity is preferably used as described in the following.

The frame (2), on the side of the first portion (50d), preferably comprises two vertical columns with respect to which the temporary magazine (20) moves.

Numerous movement means of the store are possible for moving the temporary magazine (20), for example a rack elevator. The store movement means preferably comprise a motor (20a) and a vertical linear guide (20d). In the appended figures the store movement means further comprise movement belts (20c) which bear the temporary magazine (20) and a chain transmission (20b) which transmits the motion from the motor (20a) to the movement belts (20c).

Regarding the temporary magazine (20), this might be vertically movable on a column and rotating with respect thereto, a simple and effective realisation is obtained with the temporary magazine (20) coupled to the frame (2) so as to be vertically movable in front of the first portion (50d) and which translates vertically in front of the first portion (50d).

As already mentioned above, the vertical mobility enables reaching a position of minimum distance between the first access (21) and an opening (33), so as to facilitate the filling of the container (3) and, possibly, the receiving thereof from the container (3).

Numerous transfer means are known; in the prior art, gripper units are typically used, which pick up and release. Gripper units in the prior art might used to receive, from the container (3), locate on the shelving unit, extract from the shelving unit and fill the container (3).

A more rapid and/or sturdier storage unit (1) of articles is obtained the transfer means that comprise a belt conveyor which comprises a movable belt (24) towards the second access (22) and/or towards the first access (21) and at least a flight (25a, 25b) which extends from the belt (24) so as to push articles (A) beyond the second access (22) and/or beyond the first access (21).

In the present description, by the term flight (25a, 25b) is meant any element that is conformed in such a way that, once positioned on the belt (24), it contacts the article (A) so as to push it when the article (A) does not follow the movement of the belt (24); in the reference sector it is common to use various terms for components that in any case succeed in pushing the article (A) in outlet from the belt (A), for example “paddle”.

As is shown in FIGS. 27 and 29 the at least a flight (25a, 25b) ensures that the article (A) is located or goes to fill the container (3). This is particularly useful in filling the container (3) but can also be useful in the positioning on the shelving unit.

The presence of a belt conveyor is well adapted to receiving from the containers (3), which occurs by force of gravity, especially when the containers (3) are deep, for example having a depth of double the length of the article (A). In these cases the collection of the containers (3) with gripper units would be difficult.

The belt conveyor comprises a motor which can be integrated with or external of a roller which moves the belt (24).

The belt (24) can be managed with one flight (25a, 25b), and in this case the at least a flight (25a, 25b) of FIGS. 27 and 29 is the same, interposed between the free portion (PL1) and the free part (PL2). With two flights of the at least a flight (25a, 25b) the free portion (PL1) and the free part (PL2) can be the same and accelerate the inbound operations.

The transfer means preferably comprise a pick-up unit (26), for collecting articles (A), which is movable so as to transfer articles (A) through the second access (22).

As shown by way of example in FIG. 29, the pick-up unit (26) enables the extraction from a shelving unit, enabling returning the article (A) onto the free part (PL2) via the second access (22).

The foregoing contains a discussion of the possibility that the pick-up unit (26) is movable in order to transfer articles (A) through the first access (21) towards and/or from the containers (3).

The pick-up unit (26) preferably comprises a first hand (26a) and a second hand (26b), movable with respect to one another to pick up an article (A). In a preferred embodiment, as shown by way of example in the appended figures, the first hand (26a) and the second hand (26b) are movable along a first linear guide (26c), which is arranged perpendicularly to the direction that joins the first access (21) and the second access (22) and which is movable on a second linear guide (26d) arranged perpendicularly, i.e. in the direction that joins the first access (21) and the second access (22).

The support system (5) of the self-moving storage unit (1) of articles, or a transportable storage unit (1) of articles, preferably supports the containers (3) in such a way that, i.e. is preferably configured in such a way that, each container has the opening (33) facing towards the ground surface (G) in the lower portion (50b) so as to cause the articles (A) to fall by force of gravity.

This mode of receiving the articles (A) from the containers accelerates and simplifies both the realisation and the use of the invention. For example, the fall of the articles (A) by force of gravity towards the temporary magazine (20) avoids the issues in the transfer of the articles (A), through the first access (21) towards and/or from the containers (3), in the case where the first portion (50d) and/or the second portion (50e) are inclined with respect to a vertical plane (V).

For each embodiment of the storage unit of articles (1) illustrated in the foregoing, i.e. of the self-moving or transportable type, the support system (5) preferably comprises at least a flexible organ (51, 52) to which the containers (3) are fixed so as to realise the closed looped pathway in a simple way.

More preferably, the at least a flexible organ (51, 52) is a chain or a band or a belt, in the broadest definition, i.e. comprising mesh belts, for example metal, slat, net or the like. As schematically illustrated in FIG. 1 the containers (3) might be directly fixed to the flexible organ (51) which might be a belt, as in the case of FIG. 1.

Other particularly effective and/or simple versions are however possible.

For each embodiment, as can be observed in FIG. 9, the support system (5) can comprise a first flexible organ (51) with fittings (51a), a second flexible organ (52) with fittings (52a), positioned away from the first flexible organ (51), with the containers (3) fixed to the fittings (51a, 52b) of the first flexible organ (51) and the second flexible organ (52) directly or indirectly.

The support system (5) more preferably comprises connecting elements (53), and each connecting element (53) is fixed at least to a fitting (51a) of the first flexible organ (51), at least to a fitting (52a) of the second flexible organ (52) and to a respective container (3).

Each connecting element (53) is preferably fixed to the container (3) on the opposite side of the opening (33).

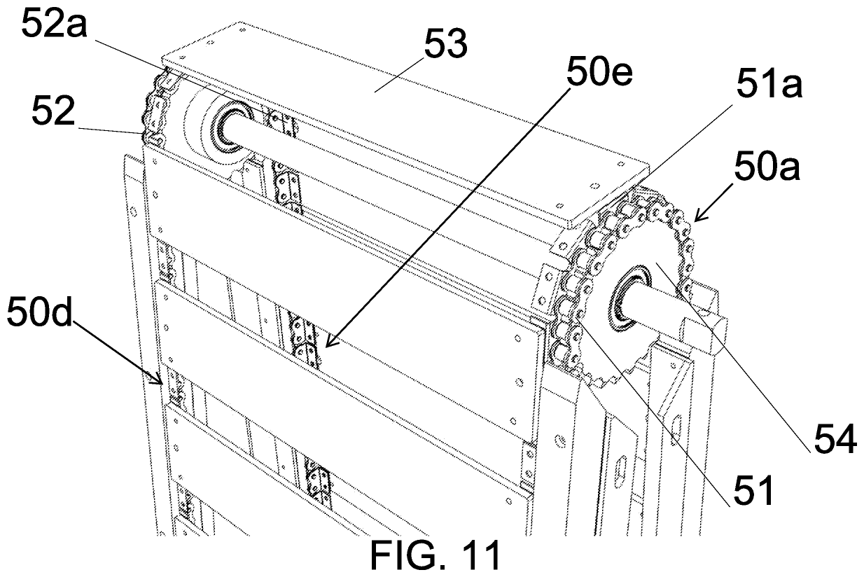

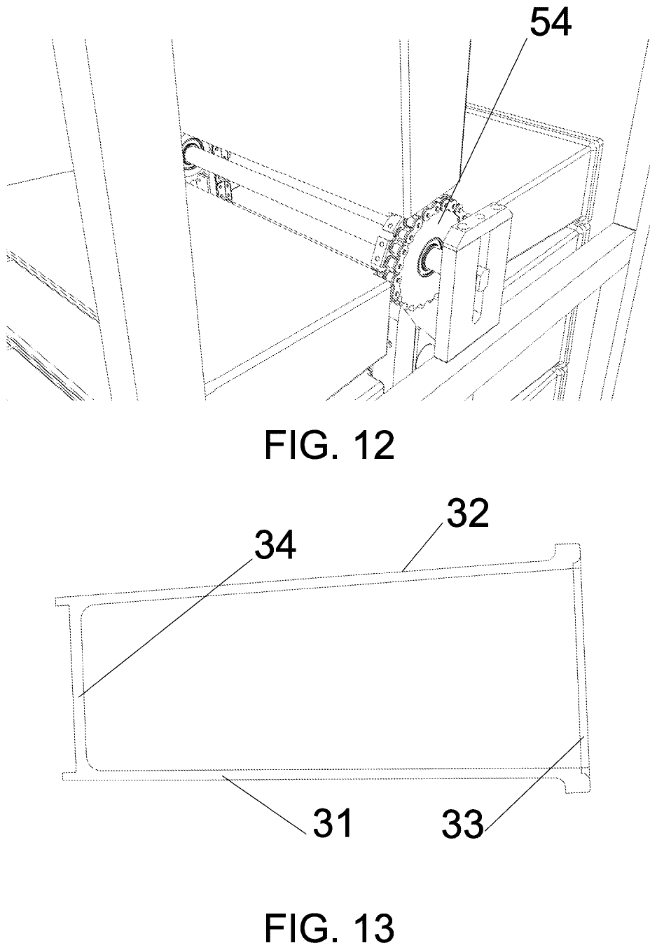

The at least a flexible organ (51, 52) with fittings can be, for example, a flexible organ with wings; preferably, though not necessarily, a chain with wings as illustrated in FIGS. 11 and 12.

For each embodiment, a container (3) preferably comprises a base (34), opposite the opening (33), from which the first part (31) and the second part (32) extend which are opposite one another with respect to the base (34). In this case is it preferable for the connecting element (53) to be fixed to the base (34). For example in the case of FIG. 12 the connecting element (53) is housed at the base (34) between the protuberances that can be seen in FIG. 13.

In other versions the connecting element (53) and/or the at least a flexible organ (51, 52) might be used to oppose the exit of the articles (A).

The container (3) is preferably shaped as a pouch or basket.

The container (3) is preferably made by moulding and has the first part (31) and the second part (32) which broaden from the base (34) towards the opening (33) so as to facilitate moulding.

The foregoing has been a discussion of the advantages deriving, regardless of the particular embodiment, from a first part (31) and a second part (32) which broaden towards the opening (33), as illustrated by the internal lines of the containers schematically illustrated in FIG. 21.

For each embodiment, the support system (5) preferably comprises a pulley or upper roller (54) and a pulley or lower roller (55) both rotatable with respect to the frame (2) and coupled to the at least a flexible organ (51, 52).

Typically the upper portion (50) corresponds to the engaging portion between the pulley or upper roller (54) and the at least a flexible organ (51, 52) and the lower portion (50b) corresponds to the engagement between the pulley or lower roller (55) and the at least a flexible organ (51, 52).

The pulley or upper roller (54) and the pulley or lower roller (55) preferably have rotation axes which lie on a same vertical plane (V), i.e. they are mutually superposed, and the pulley or upper roller (54) has a lower diameter of the pulley or lower roller (55) so that both the first portion (50d) and the second portion (50e) are inclined with respect to a vertical plane (V) in such a way that the pathway broadens towards the lower portion (50b), in a similar way to in FIG. 21.

The movement means (6) might be borne by the frame (2) or by the self-moving base (73), for example they might comprise a motor coupled to the or integrated in the pulley or lower roller (55), or a gear reducer. These configurations have a series of negative consequences; among which the greater empty mass of the storage unit (1) of articles, the costs, the need for energy and, in the case of a halt of the storage unit of articles in a storage area (102), the limited use in terms of time of the motor or the gear reducer.

The motor might also be borne by an automatically-guided vehicle or an autonomous vehicle (71), with impacts on the mass thereof, on the transportable mass and on the energy reserve.

Also in the presence of a battery unit (73c) or an energy reserve of an automatically-guided vehicle, or an autonomous vehicle, it can be advantageous to have another source of energy available.

For each embodiment, the support system (5) preferably comprises coupling means for coupling the pulley or lower roller (55) or the pulley or upper roller (54), more preferably the pulley or lower roller (55), to distinct further movement means (6), i.e. external, to the storage unit (1) of articles, so as to move the containers (3) with respect to the frame (2). The coupling means comprise a couplable gearing (56). The couplable gearing (56) is preferably mounted on the axis of the pulley or lower roller (55) or the coupling means comprise a connecting shaft between them. The couplable gearing (56) can be configured, for example, so as to engage motion transmission means installed at a station (101, 102) for loading and/or collecting articles (A) or another means for transmission of the motion borne by displacement means for displacing the storage unit (1) of articles, for example an automatically-guided vehicle or an autonomous vehicle (71).

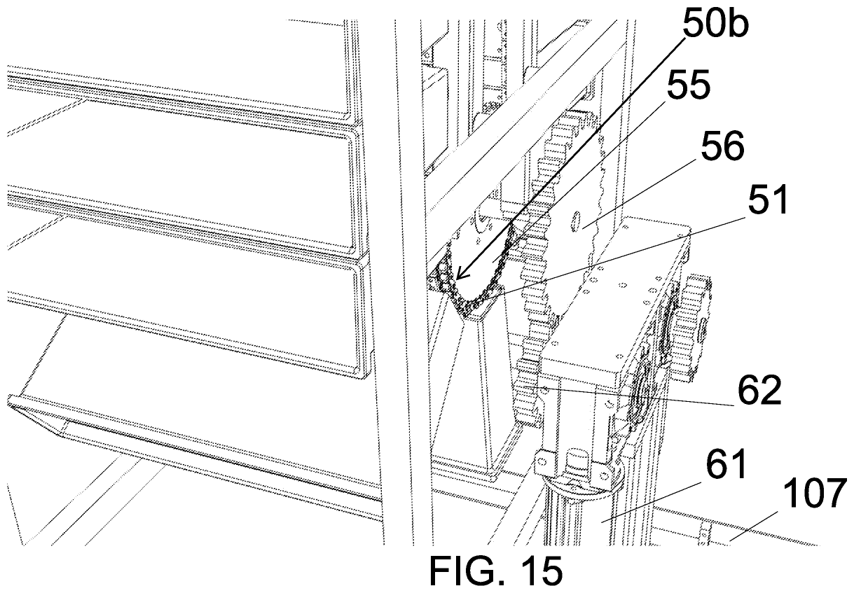

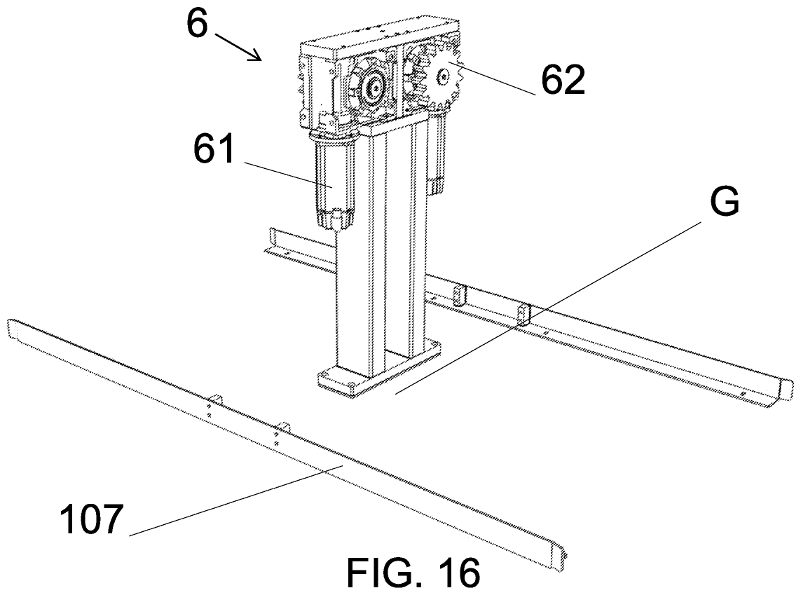

As can be observed in FIGS. 15 and 16, the couplable gearing (56) can be a gearwheel. In these figures, the motors (61) of the further movement means (6) can be seen. FIGS. 24 and 25 illustrate the motors (61) of the movement means (6) borne by the frame (2).

The storage unit (1) of articles preferably comprises containment means (11) at the lower portion (50b) configured to oppose the exit of the articles (A) from the openings (33).

With the containment means (11) it is possible to determine, with greater precision, at least a collection point or area of the articles (50c).

The containment means (11) are preferably solidly constrained to the frame (2). For example the containment means (11) can comprise a part confirmed like the pathway that prevents the exit of the articles (A).

The containment means (11) can comprise or be coated with an anti-friction material towards the containers (3).

The containment means (11) preferably comprise one or more walls, for example realised using sheet steel or by moulding.

A self-moving storage unit (1) of articles preferably comprises a door (10) for passage of the articles (A) movable between a closed position, in which it prevents passage, and an open position, in which it allows passage of the articles (A).

The door (10), or the doors, is arranged in the lower portion (50b).

The door (10) is preferably made at the containment means (11), as can be seen in FIG. 6 or in FIG. 23; in both figures the door (10) is in an open position.

With the door (10) it is possible to cross the lower portion (50b) with the containers (3) containing articles (A). This is useful in various contexts, for example in sortering.

Each embodiment is advantageously applied in a store (100) of articles (A).

An embodiment of the store (100) of articles (A) comprises at least a self-moving storage unit of articles (1) or a storage system of articles (A) according to the present description, a first station (101) for loading and/or collecting articles (A) and/or a second station (102) for loading and/or collecting articles, and a store management system (1000) which controls the displacement means and the movement means (6).

The store (100) of articles (A) preferably comprises also a storage area (103) of the at least a storage unit (1) of articles and can comprise further movement means (6) for moving the support system (5) so as to move the containers (3) with respect to the frame (2).

The invention also relates to a store (100) of articles (A).

An embodiment of the store (100) of articles (A) comprises at least a storage unit of articles (1) of a self-moving or transportable type according to the present description, movement means (6) for moving the support system (5) so as to move the containers (3) with respect to the frame (2), displacement means for displacing the at least a storage unit of articles (1), a first station (101) for loading and/or collecting articles (A), a storage area (103) of the at least a storage unit of articles (1) and/or a second station (102) for loading and/or collecting articles (A), and a store management system (1000) which controls the displacement means and the movement means (6).

The store management system (1000) is of known type and can be physical, virtual or mixed, for example in a cloud. By way of example, the store management system (1000) can comprise an application server and a data store. The server typically comprises one or more processing units or processors and at least a memory and is configured to carry out instructions. In general it also comprises a communication channel, a net interface, a graphic controller and input/output interfaces.

As already illustrated in the foregoing, and better detailed in the following, the movement means (6) can be borne by the at least a storage unit of articles (1) or distinct therefrom so as to be able to be more easily powered and not to reduce the storable load.

Likewise the at least a storage unit of articles (1) can be self-moving or, more preferably, can be transported by displacement means external thereto; in both cases with the use of known devices.

The displacement means preferably comprise at least an automatically-guided or autonomous vehicle (71). As is known to the technical expert in the field, a group of automatically-guided or autonomous vehicles (71) can move a plurality of storage units of articles (1) interchangeably and/or with the possibility of having a storage unit (1) of articles not associated to any automatically-guided or autonomous vehicle (71) for a period of time.

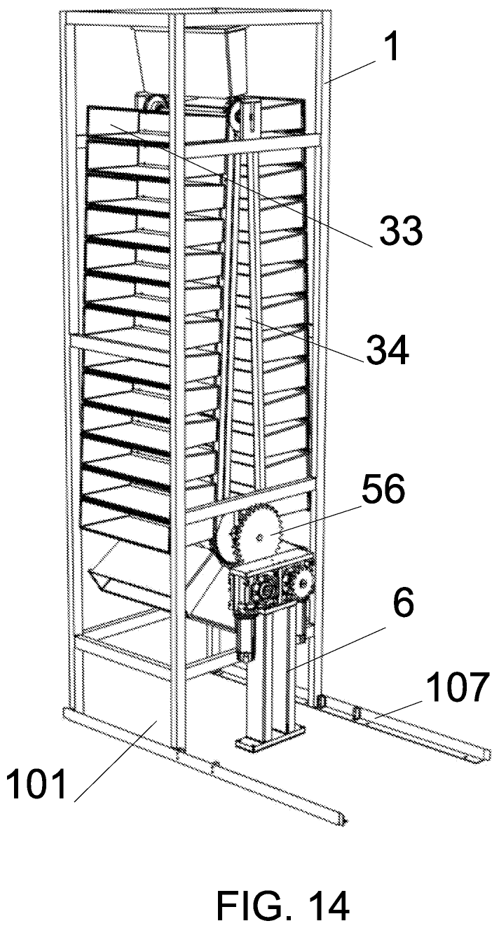

The further movement means (6) preferably comprise motion transmission means installed at the first station (101) and configured so as to transmit the motion to the support system (5) when the at least a storage unit of articles (1) is in the first station (101). The availability of stations (101, 102), such as the one represented by way of example in FIG. 14, reduces the cost, the mass and the realisational and management complications of the storage unit (1) of articles with a minimum impact on the realising of the store (100) of articles (A).

The store (100) of articles (A) preferably comprises guides (107) installed at the first station (101) to guarantee the correct positioning of the storage unit (1) of articles and, possibly, of the motion transmission means. The further movement means (6) preferably comprise at least a motor (61) which moves the motion transmission means and which is installed at the first station (101).

The motion transmission means preferably comprise a cogwheel (62) configured for coupling with the coupling means, in particular with the couplable gearing (56) visible in FIG. 15. The motion transmission means preferably also comprise a planetary gear.

A self-moving storage unit (1) of articles preferably comprises a door (10) for passage of the articles (A) movable between a closed position, in which it prevents passage, and an open position, in which it allows passage and the displacement means comprise a device (72) configured to open or close the door (10).

The device (72) can be, for example, an actuator of known type for vehicles having an automatic drive (71).

In this case too, the door (10) might be activated by an actuator of the storage unit (1) of articles or an actuator might be installed at the first station (101).

The store (100) of articles (A) preferably comprises loading means for loading articles (A) in the containers (3).

The positioning of the articles (A) in the containers (3) can be done following various logical systems. The store management system (1000) can manage the movement of the articles (A) towards the containers (3) and/or the movement of the containers (3). In figures from 3 to 5, the loading means have a fixed velocity, for example because an operator loads the moved-away articles (A), and the store management system (1000) controls the movement of the containers (3). In other versions, the loading means might also be controlled on the basis of the availability of one or more free containers (3).

The loading means preferably have an unloading area of the articles (90) and preferably comprise a transporter or conveyor, for example a belt conveyor (91), as can be seen in FIG. 3.

The store management system (1000) preferably comprises recognition means for recognising the articles (A) and/or the reading means for reading identifiers (4) of the containers (3).

The reading means preferably comprise a barcode reader (81), comprising two-dimensional barcodes, or a reader (81) of radio frequency labels, more preferably installed at the first station (101).

The reading means can read the identifier (4) before, during or after the article (A) has been placed in the container (3), for example taking account of the movement of the containers (3) which are or which have been carried out.

There are numerous known devices which can have the function of recognition means.

For example the recognition means can comprise a data entering device or input device, a first barcode reader (92), a recognition system with a camera and/or video camera, etc. The recognition means often comprise a plurality of devices, integrated in a portal or a station (101, 102). The recognition means preferably comprise a first optical barcode reader (92). The recognition means more preferably comprise mass detectors and/or size detectors of the articles (A).

The at least a storage unit (1) of articles preferably comprises an identifier (4) for each container (3) carried by the respective container (3). In this case the store management system (1000) can be configured to associate each article (A) to the identifier (4) of the container (3) than contains it. Further, the store management system (1000) can control the loading means and/or the movement means (6) and can be configured in such a way that each container (3) contains at most one article (A). Advantages are thus obtained in the management of the articles (A) in the store (100) of articles (A), which is facilitated due to the relation between the container (3) and the article (A) containing it.

The store (100) of articles (A) preferably comprises a transporter or conveyor (106) of articles (A) and a plurality of stations (101, 102) of the at least a storage unit of articles (1). The stations are arranged in succession at the position of the transporter or conveyor (106) so that the at least a self-moving storage unit of articles (1) places the articles (A) on the transporter or conveyor (106) when it is at a station of the plurality of stations (101, 102).

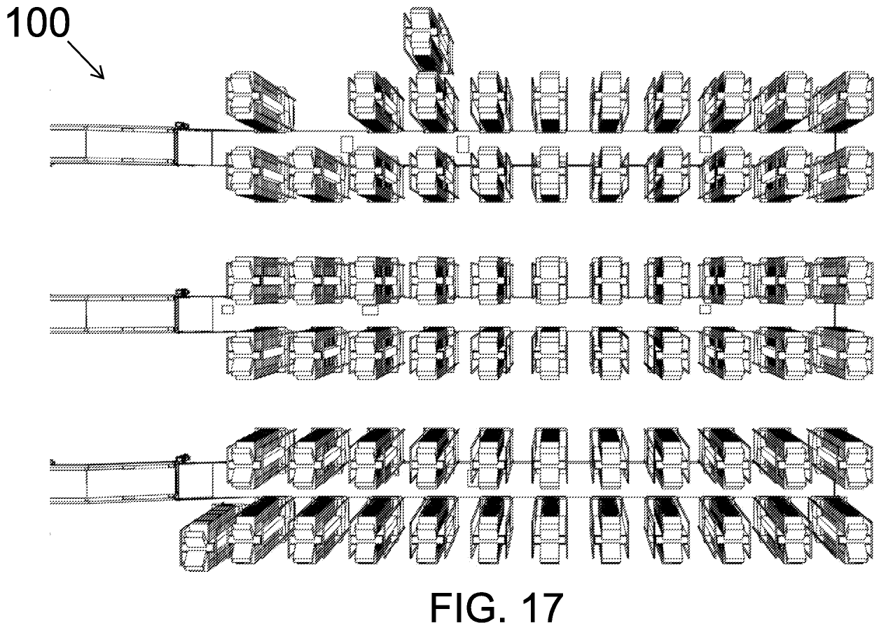

It is thus possible to make rapid and/or automated transfers of the articles (A) as is shown by way of example in FIGS. 17, 18 and 19. In FIGS. 17 and 18 the belt conveyors can carry the articles (A) to other areas in the store (100) of articles (A) or to several outlet points which have different destinations or activities.

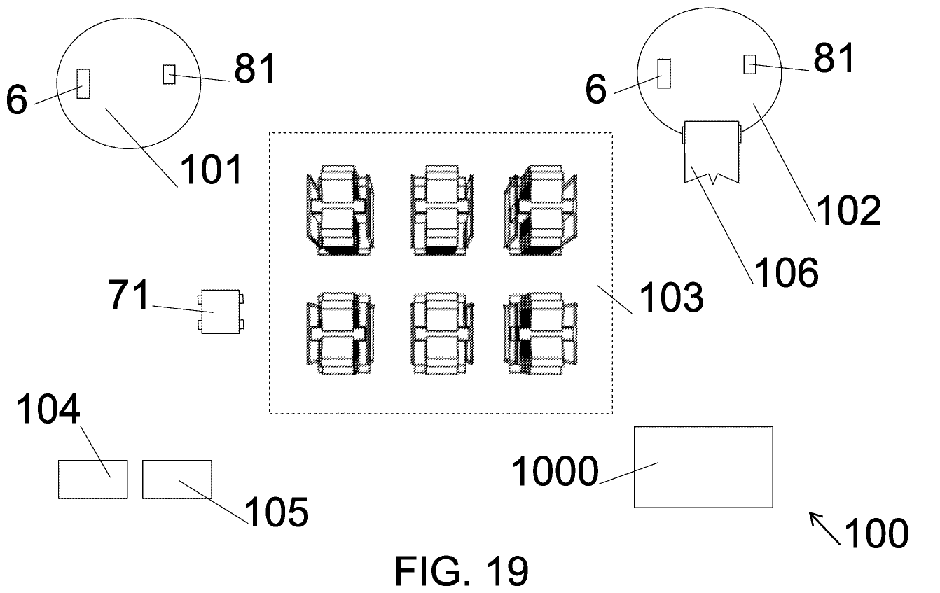

FIG. 19 illustrates an embodiment of the store (100) of articles (A) that is particularly complete, comprising a first station (101), a second station (102) with a transporter or conveyor (106), a storage area (103) of the at least a storage unit of articles (1), a store management system (1000) and a first receptacle (104) and a second receptacle (105).

FIGS. 17, 18 and 19 are illustrations by way of example of the invention in the case of a plurality of storage units of articles (1) according to the invention.

The invention also relates to a method for collecting articles (A).

An embodiment of the method comprises steps of:
providing at least an embodiment of a storage unit of articles (1) or a storage system of articles (A) according to the present description;
providing articles (A);
placing the articles (A) in the containers (3) in the second portion (50e) and/or in the first portion (50d);
collecting an article (A), preferably moving the support system (5) as long as the container that contains it is in the lower portion (50b).

The storage unit of articles (1) can be configured and/or can be used in various different approaches, some of which are described in the following.

According to a first approach the loading takes place when the container (3) is at a point or area of the first portion (50d) with the movement means (6) moving the containers in such a way that the loaded containers (3) are directed towards the second portion (50e) then to be unloaded at a point or area of the lower portion (50b) beneath the second portion (50e).

In a first embodiment, after the loading of the containers (3), the movement means (6) move the containers (3) in an opposite direction in order to be unloaded at a point or area of the lower portion (50b) beneath the first portion (50d).

The two variants can be combined so as to have two collection points or areas of the articles (50c).

According to a second approach the storage unit (1) of articles comprises a pick-up unit (26), or a temporary magazine (20), which can collect from and/or fill the containers (3); this approach can be integrated with the ones illustrated in the foregoing.

Containment means (11) at the lower portion (50b) enable more flexible management of the movement of the containers (3), so that one or more doors (10) increase the flexibility in terms of articles (A) collected, facilitating the sortering.

Preferably, in the step of providing at least an embodiment of a storage unit (1) of articles or a storage system of articles (A) according to the present description, a self-moving storage unit (1) of articles is provided, or a storage system of articles (A) is provided which comprises a temporary magazine (20) as illustrated in the foregoing the step of collecting an article (A) comprises the step of vertically moving the temporary magazine (20).

The vertical movement of the temporary magazine (20) enables varying the height of the article being loaded in and/or extracted, as well as enabling placing the first access (21) in front of different openings (33). The advantages of the vertical movement of the temporary magazine (20) have been illustrated in the foregoing, with reference to the appended figures.

Preferably, in the step of providing at least an embodiment of a storage unit (1) of articles or a storage system of articles (A) according to the present description, a transportable storage unit (1) of articles is provided, or a storage system of articles (A) which comprises a belt conveyor and at least a flight (25a, 25b) as illustrated in the foregoing and the step of collecting an article (A) comprises steps of:
activating the belt conveyor so as to position a first flight (25a) of the at least a flight (25a, 25b) in a retracted position so that the first flight (25a) is behind a free portion (PL1) of belt (24) in the movement direction of the belt (24) towards the second access (22);
unloading a container (3) onto the belt (24) so as to position an article on the free portion (PL1) of belt (24);
activating the belt conveyor so as to move the first flight (25a) towards the second access (22).

In this way a secure and rapid location is obtained.

Preferably, in the step of providing at least an embodiment of a storage unit (1) of articles or a storage system of articles (A) according to the present description, a transportable storage unit (1) of articles is provided, or a storage system of articles (A) which also comprises, as well as the belt conveyor and at least a flight (25a, 25b), a pick-up unit (26) as illustrated in the foregoing and the step of placing the articles (A) comprises steps of:
activating the belt conveyor so as to position a flight (25b) of the at least a flight (25a, 25b) in a respective retracted position so that the flight is behind a free part (PL2) of belt (24) in the movement direction of the belt (24) towards the first access (21);
gripping an article (A) with the pick-up unit (26);
bringing the gripped article (A) onto the free part (PL2) of belt (24);
vertically moving the temporary magazine (20) with the article (A) borne until the first access (22) is in front of an opening (33);
activating the belt conveyor so as to move the flight (25b) towards the first access (21).

In this way a secure and rapid filling of a container (3) is obtained.

FIG. 31 illustrates an embodiment of the method in which, in the step of placing the articles (A), the belt conveyor is activated so that the at least a flight (25a, 25b) guarantees the loading of the containers (3).

Preferably, in the step of providing at least an embodiment of a storage unit (1) of articles or a storage system of articles (A) according to the present description, a storage unit (1) of articles is provided, of the self-moving or transportable type, or a transportable storage unit (1) of articles is provided, or a system, which comprise a support system (5) which supports the containers (3) in such a way that, or is configured so that, each container has the opening (33) facing towards the ground surface (G) in a lower portion (50b) so as to cause the articles (A) to fall by force of gravity and the method comprises steps of:
receiving a request for a stored article (A);
activating the movement means (6) so as to bring the container (3) which carries the requested article (A) into the lower portion (50b).

The method more preferably also comprises the step of:
providing a store (100) of articles (A) according to the present description;
identifying a storage unit of articles (1) which stores the requested article;
displacing the identified storage unit (1) of articles.

Preferably, during the step of displacing the identified storage unit of articles (1), the unit is moved from a storage area (103) of the at least a storage unit of articles (1).

In the case of sortering the displacement might take place from the first station (101) to the second station (102).

After the step of placing the articles in the containers (3), the step as follows can take place:
taking the storage unit (1) to a storage area (103) of the at least a storage unit of articles (1).

According to the applications the at least a storage unit of articles (1) can remain waiting in the storage area (103) for minutes or days.

The at least a storage unit (1) of articles preferably comprises an identifier (4) for each container (3) carried by the respective container (3) and the method comprises steps of:
recognising the articles (A);
associating the identifier (4) of the container (3) to the placed article (A);
receiving a request for a stored article (A);
recuperating the identifier (4) associated to the requested article (A).

Further, the step of collecting an article (A) brings the container (3) bearing the recuperated identifier (4) to a collection point or area of the articles (50c).

The association of an identifier (4) of a container (3) to the article (A) facilitates the management of the store (100) of articles (A), due to a unique tracing of the article (A), thus limiting or avoiding the need for further recognition of the article (A).

Here and in the foregoing, the identifier (4) can be, for example, a barcode, comprising two-dimensional barcodes or data matrix, either a radio-frequency label, or a sequence of characters. The identifier (4) can preferably be a barcode. The embodiment of FIG. 9 comprises a radio-frequency label (not visible in the figure) but might have a barcode as in the illustration in FIG. 1.

The method preferably comprises steps of:
providing receptacles (104, 105), each for receiving articles (A) from the at least a storage unit (1) of articles;
receiving an instruction to arrange a placed article (A) in a second receptacle (105);
recuperating the identifier (4) associated to the requested article (A) in the second receptacle (105);
displacing the at least a self-moving storage unit of articles (1) with the identifier (4) associated to a first receptacle (104) to the second receptacle (105);
activating the movement means (6) so as to bring the container (3) which carries the recuperated identifier (4) into a collection point or area of the articles (50c).

The method of the invention is advantageously applicable in a case of a plurality of receptacles (104, 105) such as for example, in the case of sortering.

It is understood that the above has been described by way of non-limiting example and that any constructional variants are considered to fall within the protective scope of the present technical solution, as claimed in the following.

1) A storage unit of articles of a self-moving or transportable type, comprising:
a frame;
containers for articles, each comprising a first part, a second part and, between the first part and the second part, an opening for entry and outlet of the articles;
wherein the storage unit of articles comprises a support system which supports the containers in such a way that:
the containers are movable with respect to the frame according to a closed looped pathway which has an upper portion, a lower portion, a first portion which extends in a vertical direction and a second portion which extends in a vertical direction, with the upper portion and the lower portion both being interposed between the first portion and the second portion;
a plurality of containers is mutually overlapped in the first portion and a plurality of containers is mutually overlapped in the second portion;
each container has the first part above the second part in the first portion, the second part above the first part in the second portion, the opening facing in a moving away direction from the containers of the second portion in the first portion and the opening facing towards the ground surface in the lower portion so as to cause the fall of the articles by force of gravity;
and wherein the containers and the pathway are configured in such a way that the second part in the first portion and the first part in the second portion are horizontal or inclined with respect to a horizontal plane so as to prevent the fall of the articles.

2) (canceled)

3) The storage unit of articles of claim 1, wherein at least one from between the first portion and the second portion is inclined with respect to a vertical plane in such a way that the pathway broadens towards the lower portion.

4) The storage unit of articles of claim 1, wherein: the support system comprises at least a flexible organ to which the containers are fixed;
the at least a flexible organ is a chain or a band or a belt, with the belt being also of a mesh, slat or net type;
the support system comprises a first flexible organ with fittings, a second flexible organ with fittings, positioned away from the first flexible organ, and connecting elements, each connecting element being fixed at least to a fitting of the first flexible organ, at least to a fitting of the second flexible organ and to a respective container; and
the support system comprises a pulley or upper roller and a pulley or lower roller both rotatable with respect to the frame and coupled to the at least a flexible organ.

5) (canceled)

6) (canceled)

7) (canceled)

8) The storage unit of articles of claim 1, wherein the support system comprises at least a flexible organ to which the containers are fixed, comprises a pulley or upper roller and a pulley or lower roller both rotatable with respect to the frame and coupled to the at least a flexible organ and comprises coupling means for coupling the pulley or lower roller or the pulley or upper roller to movement means distinct from the storage unit of articles, so as to move the containers with respect to the frame and wherein the coupling means comprise a couplable gearing.

9) The storage unit of articles of claim 1, comprising containment means at the lower portion configured to oppose the exit of the articles from the openings.

10) The storage unit of articles of claim 1, comprising a door for passage of the articles movable between a closed position, in which it prevents passage, and an open position, in which it allows passage.

11) A store of articles comprising at least the storage unit of articles of claim 1, movement means for moving the support system so as to move the containers with respect to the frame, displacement means for displacing the at least a storage unit of articles, a first station for loading and/or collecting articles, a storage area of the at least a storage unit of articles and/or a second station for loading and/or collecting articles, and a store management system which controls the displacement means and the movement means.

12) The store of articles of claim 11, wherein the movement means comprise motion transmission means installed at the first station (101) and configured so as to transmit the motion to the support system when the storage unit of articles is in the first station.

13) (canceled)

14) (canceled)

15) A storage system of articles comprising a storage unit of articles, the storage unit of articles comprising:
a frame;
containers for articles, each comprising a first part, a second part and, between the first part and the second part, an opening for entry and outlet of the articles;
wherein the storage unit of articles is self-moving and comprises displacement means for displacing the frame or the storage unit of articles is transportable and the storage system of articles comprises displacement means for displacing the frame;
wherein the storage unit of articles comprises a support system which supports the containers in such a way that:
the containers are movable with respect to the frame according to a closed looped pathway which has an upper portion, a lower portion, a first portion which extends vertically and a second portion which extends vertically, with the upper portion and the lower portion being both interposed between the first portion and the second portion;
a plurality of containers is mutually overlapped in the first portion and a plurality of containers is mutually overlapped in the second portion;
each container has the first part above the second part in the first portion, the second part above the first part in the second portion and the opening facing in a moving away direction from the containers of the second portion in the first portion,
wherein the storage unit of articles comprises movement means for moving the support system so as to move the containers with respect to the frame and
in that wherein the containers and the pathway are configured in such a way that the second part in the first portion and the first part in the second portion are horizontal or inclined with respect to a horizontal plane so as to prevent the falling of the articles.

16) The storage system of articles of claim 15, wherein the containers and the path are configured in such a way that the second part in the first portion and the first part in the second portion are inclined with respect to a horizontal plane so as to prevent the falling of the articles.

17) The storage system of articles of claim 15, comprising a temporary magazine which:
comprises a first access for passage of the articles on a first side;
comprises a second access for passage of the articles on a second side opposite the first side;
comprises transfer means for transferring articles through the first access and/or for transferring articles through the second access;
is vertically movable with respect to the frame passing from at least a loading and/or unloading position in which the first access is facing towards an opening so as to enable the transfer of the articles from and/or towards a container.

18) The storage system of articles of articles of claim 17, wherein the temporary magazine is coupled to the frame so as to be vertically movable in front of the first portion and wherein the temporary magazine translates vertically in front of the first portion.

19) The storage system of articles of claim 17, wherein the transfer means comprise a belt conveyor which comprises a belt that is movable towards the second access and/or towards the first access and at least a flight which extends from the belt so as to push articles beyond the second access and/or beyond the first access.

20) The storage system of articles of claim 19, wherein the transfer means comprise a pick-up unit, for collecting articles, which is movable so as to transfer articles through the second access.

21-26) (canceled)

27) A method for collecting articles comprising steps of:
providing a storage system of articles according to claim 15;
providing articles;
placing the articles in the containers in the second portion and/or in the first portion;
collecting an article.

28) The method of claim 27, wherein in the step of providing a storage system of articles, the storage system of articles comprises a temporary magazine, which comprises:
a first access for passage of the articles on a first side;
a second access for passage of the articles on a second side opposite the first side; and
transfer means for transferring articles through the first access and/or for transferring articles through the second access,
wherein the temporary magazine is vertically movable with respect to the frame passing from at least a loading and/or unloading position in which the first access is facing towards an opening so as to enable the transfer of the articles from and/or towards a container,
wherein the step of collecting an article comprises the step of vertically moving the temporary magazine.

29) The method of claim 28, wherein in the step of providing a storage system of articles the transfer means comprise a belt conveyor which comprises a belt that is movable towards the second access and/or towards the first access and at least a flight which extends from the belt so as to push articles beyond the second access and/or beyond the first access,
wherein the step of collecting an article comprises steps of:
activating the belt conveyor so as to position a first flight of the at least a flight in a retracted position so that the first flight is behind a free portion of belt in the movement direction of the belt towards the second access;
unloading a container onto the belt so as to position an article on the free portion of belt;
activating the belt conveyor so as to move the first flight towards the second access.

30) The method of claim 28, wherein in the step of providing a storage system of articles the transfer means comprise a pick-up unit, for collecting articles, which is movable so as to transfer articles through the second access,
wherein the step of placing the articles comprises steps of:
activating the belt conveyor so as to position a flight of the at least a flight in a respective retracted position so that the flight is behind a free part of belt in the movement direction of the belt towards the first access;
gripping an article with the pick-up unit;
bringing the gripped article onto the free part of belt;
vertically moving the temporary magazine with the article borne until the first access is in front of an opening;
activating the belt conveyor so as to move the flight towards the first access.

31) The storage system of articles of claim 17, wherein the transfer means comprise a pick-up unit, for collecting articles, which is movable so as to transfer articles through the second access.
